(19) United States
(12) Patent Application Publication
(10) Pub. No.: US 2026/0321078 A1
(43) Pub. Date: Oct. 15, 2026

(54) SYSTEM AND METHOD FOR PARING AN OFFLINE KEY FOB TO A VEHICLE USING VEHICLE CONNECTIVITY

(71) Applicant: Ford Global Technologies, LLC, Dearborn, MI (US)

(72) Inventors: Jochen Schubert, Farmington Hills, MI (US); Timothy Thivierge, JR., Carleton, MI (US); Aaron Bonnell-Kangas, Detroit, MI (US); Eugene Karpinsky, Farmington Hills, MI (US); Fouad Bounefissa, Oakville (CA); Kevin Thomas Hille, Plymouth, MI (US); Antony Mihalopoulos, Saline, MI (US)

(21) Appl. No.: 19/174,029

(22) Filed: Apr. 9, 2025

(51) Int. Cl. G07C 9/00

(52) U.S. Cl. CPC G07C 9/00817; G07C 2009/00769; G07C 2009/00825; G07C 2009/00849; G07C 2009/00984

(57) ABSTRACT

A system includes a vehicle system including one or more computing devices. The vehicle system is configured to identify a user as an authorized user of a vehicle using an authorization action associated with the user in response to receiving a key pairing request to pair an offline key fob to the vehicle, verify the offline key fob as being authorized to be paired with the vehicle using an authentication information provided by the offline key fob using a short range communication protocol in response to the user being the authorized user, transmit a device payload to the offline key fob using the short range communication protocol, and pair to the offline key fob using the device payload to enable the offline key fob to control the vehicle.

### TECHNICAL FIELD

The present disclose is generally directed to pairing a key fob to a vehicle, and more particularly, pairing an offline key fob to the vehicle.

### BACKGROUND

A key fob can be paired with a vehicle to enable the key fob to access or control features of the vehicle, such as but not limited to: remote start, unlocking/locking doors of the vehicle, and/or opening rear door of the vehicle. To pair the key fob, a user may input one or more defined actuation of buttons provided on the key fob to place the key fob in a pairing mode.

### SUMMARY

In some aspects, the present disclosure is directed to a system comprising a vehicle system including one or more computing devices configured to: identify a user as an authorized user of a vehicle using an authorization action associated with the user in response to receiving a key pairing request to pair an offline key fob to the vehicle; verify the offline key fob as being authorized to be paired with the vehicle using an authentication information provided by the offline key fob using a short range communication protocol in response to the user being an authorized user; transmit a device payload to the offline key fob using the short range communication protocol; and pair to the offline key fob using the device payload to enable the offline key fob to control the vehicle.

In another aspect, the present disclosure is directed to a non-transitory computer-readable medium comprising instructions for pairing an offline key fob to a vehicle that, when executed by one or more processors perform operations including to: identify a user as an authorized user of the vehicle using an authorization action associated with the user in response to receiving a key pairing request to pair the offline key fob to the vehicle; verify the offline key fob as being authorized to be paired with the vehicle using an authentication information provided by the offline key fob using a short range communication protocol in response to the user being an authorized user; transmit a device payload to the offline key fob using the short range communication protocol; establish a secure channel with the offline key fob using cryptographic keys in response to the offline key fob validating the device payload; and pair to the offline key fob using the secure channel and the device payload to enable the offline key fob to control the vehicle.

In another aspect, the present disclosure is directed to a method of pairing an offline key fob to a vehicle. The method includes identifying, by a vehicle system, a user as an authorized user of the vehicle using an authorization action associated with the user in response to receiving a key pairing request to pair an offline key fob to the vehicle; verifying, by the vehicle system, the offline key fob as being authorized to be paired with the vehicle using an authentication information provided by the offline key fob using a short range communication protocol in response to the user being an authorized user, wherein the authentication information includes at least one of an identity certificate, a root certificate, or a private key; transmitting, by the vehicle system to a remote server, a key fob pairing request to obtain approval to pair with the offline key fob; decrypting, by the vehicle system, a signed payload message to obtain a device payload from the remote server in response to the remote server approving pairing; transmitting, by the vehicle system, the device payload to the offline key fob using the short range communication protocol; establishing a secure channel with the offline key fob using cryptographic keys in response to the offline key fob validating the device payload; and pairing to the offline key fob using the secure channel, one or more shared data, and the device payload to enable the offline key fob to control the vehicle.

### BRIEF DESCRIPTION OF THE DRAWINGS

FIG. 1 is an example vehicle system and offline key fob to be paired to the vehicle system.

FIG. 2 is an example block diagram of a vehicle system for the vehicle.

FIG. 3A is an example flow diagram of a key pairing process for an offline key fob.

FIG. 3B is a continuation of the example flow diagram of the key pairing process of FIG. 3A.

FIG. 3C is a continuation of the example flow diagram of the key pairing process of FIG. 3B.

FIG. 4 is an example flow diagram of another key pairing process of the offline key fob.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Some techniques for pairing key fobs to vehicles can include security features to limit third party attacks. For instance, some pairing techniques use short-range low-frequency radios and proprietary protocols, but these connections may lack any encryption or authentication to protect pairing data. Other pairing techniques may rely on static personal identification numbers (PINs) or passwords embedded into the key fobs to authenticate vehicle pairings, but this can present concerns with brute-forcing short PINs or leaking passwords from dealer systems that can access all values. Adding internet connectivity to the key fob can provide a direct interface for certificate management and pairing approval, but internet connectivity can increase complexity of the key fob, component cost, and amount of power needed to power the key fob.

The present disclosure is generally directed to a pairing technique for offline key fobs that uses connected telematics features of a vehicle and secure messaging payloads to pair an offline key fob to the vehicle. That is, connectivity of the offline key fob is supplemented through the vehicle or other proxies to bypass complex key fobs having internet connectivity and/or key fobs connected using PINs or passwords.

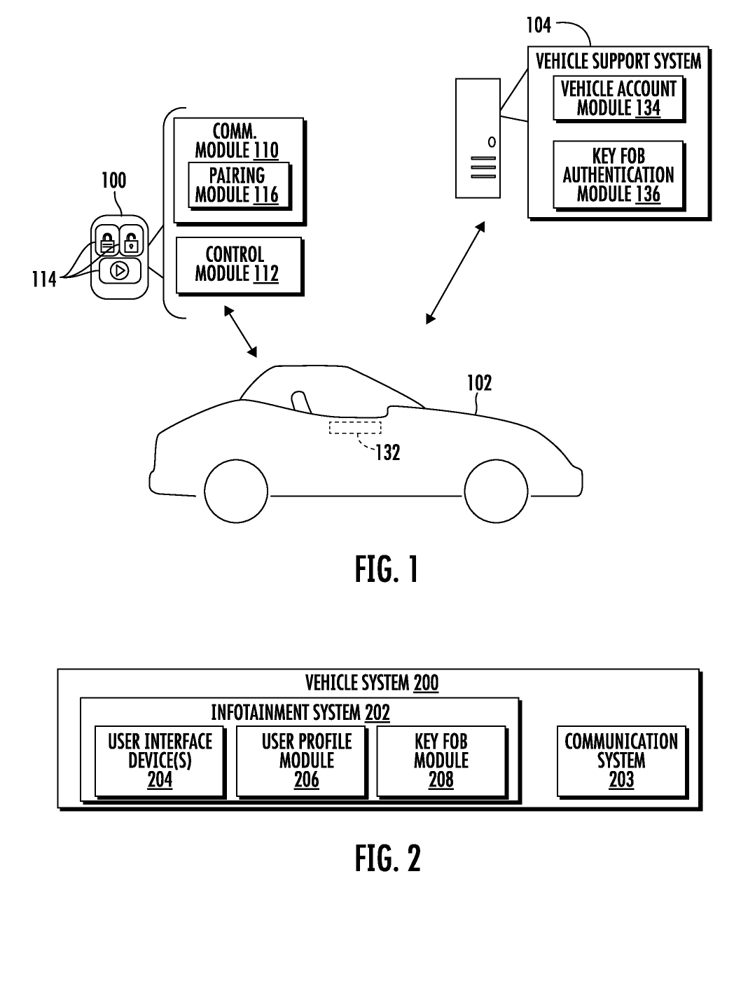

Referring to FIGS. 1 and 2, an offline key fob 100 is paired to a vehicle 102 to provide access to the vehicle 102 using a pairing process for offline keys described herein, which may be referred to as key pairing process. In some implementations, the key pairing process is performed using a vehicle support system 104 for authenticating the offline key fob 100 and the vehicle 102. In other implementations, the key pairing process is performed without the vehicle support system 104, and is executed between the vehicle 102 and the offline key fob 100.

In some aspects, the offline key fob 100 is a device providing a narrow set of functions (e.g., remote start, unlock/lock doors, open/close rear door, alarm on/off). The offline key fob 100 further lacks internet connectivity and, in some instances, is pairable to a single vehicle. In some variations, the offline key fob 100 may include limited user input-output interfaces, such as a few buttons, or touchpad, but no screens. In a non-limiting example, the offline key fob 100 may be a near field communication (NFC) proximity access card, radio frequency identification (RFID) proximity access cards, and/or wearable devices with NFC or RFID functionality designed for vehicle access.

In some aspects, the offline key fob 100 includes a communication module 110, a control module 112, and buttons 114 to control defined features of the vehicle 102. The communication module 110 may be configured to exchange signals using one or more shortrange communication protocols, such as, but not limited to: radio frequency communication, NFC, BLUETOOTH-type communication, and/or ultra-wide band (UWB) communication. In a non-limiting example, the offline key fob 100 includes hardware and software components such as: antenna, memory, and an integrated chip configured to transmit and/or receive message signals using the shortrange communication protocol.

In one form, the communication module 110 is configured to include a pairing module 116 configured to pair the offline key fob 100 to the vehicle 102 per the pairing process for offline keys of the present disclosure. In some aspects, the pairing module 116 includes a microprocessor configured to execute a pairing routine and a memory configured to store authentication information used for authenticating the offline key fob 100. In a non-limiting example, the authentication information may include an identity certificate, a root certificate, and/or a private key. The authentication information is stored by the offline key fob 100 before being paired, such as when the offline key fob 100 is being manufactured.

The control module 112 is configured to control features of the vehicle 102 based on an actuation of the button 114 once the offline key fob 100 is paired to the vehicle 102. For example, once paired, the control module 112 transmits commands to start, lock, or unlock the vehicle based on the button(s) 114 being actuated. The control module 112 may include a microprocessor and a memory for storing instructions executable by the microprocessor to command the vehicle 102 to perform a control feature in response to a respective button 114 being actuated.

While pairing module 116 is provided with the communication module 110, the pairing module 116 adapted in various suitable ways as part of the offline key fob 100 including but not limited to being part of the control module 112 or a standalone module. In addition, the offline key fob 100 may include a streamlined structure in which the communication module 110, the control module 112, and the pairing module 116 share components such as microprocessor and/or memory, and are not required to have separate components.

The vehicle 102 may be any suitable vehicle 102 having selected features controllable by a remote key fob, such as automobiles, trucks, and/or motorcycles. In a non-limiting example, the vehicle 102 includes a vehicle system 200 that includes an infotainment system 202 and a communication system 203. While specific systems are identified, the vehicle 102 may include other systems, such a vehicle drive system to control drive operation of the vehicle 102 (e.g., activating remote start, powertrain control, etc.) and/or a vehicle body system for controlling and monitoring structural components of the vehicle body (e.g., locking/unlocking doors, opening trunk, etc.).

The infotainment system 202 is configured to exchange information with a user and provide access to various auxiliary features, such as creating a user profile and/or pairing a key fob. In some implementations, the infotainment system 202 includes one or more user interface devices 204, a user profile module 206, and a key fob module 208. The infotainment system 202 may include one or more microprocessors and memory for storing instructions executable by the microprocessor to perform the operations described herein including those of the user profile module 206 and the key fob module 208.

The user interface devices 204 are configured to communicate with one or more users of the vehicle 102 by providing and receiving information to/from the users. In a non-limiting example, the user interface devices 204 include: audio devices (e.g., speaker and/or microphone), a display device(s) (e.g., a head-up display and/or a liquid crystal display with touchscreen), and/or buttons/knobs.

The user profile module 206 is configured to obtain and store data related to authorized users of the vehicle 102. In a non-limiting example, the user may be a vehicle owner, and the user profile module 206 may receive user information related to the vehicle owner from the vehicle support system 104, which stores information related to the vehicle 102 and the authorized user as part of a vehicle account. The user information may include username, unique account number associated with the authorized user and the vehicle 102, unique passcode set by the user for logging into the vehicle account, and/or operation preferences set by the authorized, such as, but not limited to, optional settings for pairing a key fob.

In some implementations, the authorized user during a key pairing process may be a technician at, for example, a manufacturing facility of the vehicle 102 or a service center for the vehicle 102. The technician may pair the offline key fob 100 using secure tools for authenticating the technician using various techniques, such as unique passcode, identification information associated with user, and/or biometric verification.

The key fob module 208 is configured to initiate the pairing process for offline key fobs 100. For example, the option to pair key fob with the vehicle 102 may be presented via to the user as part of a setting option on graphical user interfaced by the infotainment system 202. After selecting the option to pair the key fob, the key fob module 208 is configured to identify the user as being an authorized user of the vehicle 102 using an authorization action associated with the user. In a non-limiting example, the authorization action selected may include receiving a message from one or more key fobs already paired to the vehicle 102; obtaining and verifying login credentials associated with the authorized user; confirming a one-time password sent to and to be entered by the user; or a biometric authentication (e.g., fingerprint, facial recognition). Using expected responses of the authorization action, the key fob module 208 is configured to identify the user as an authorized user if the expected responses match the input of the authorization action.

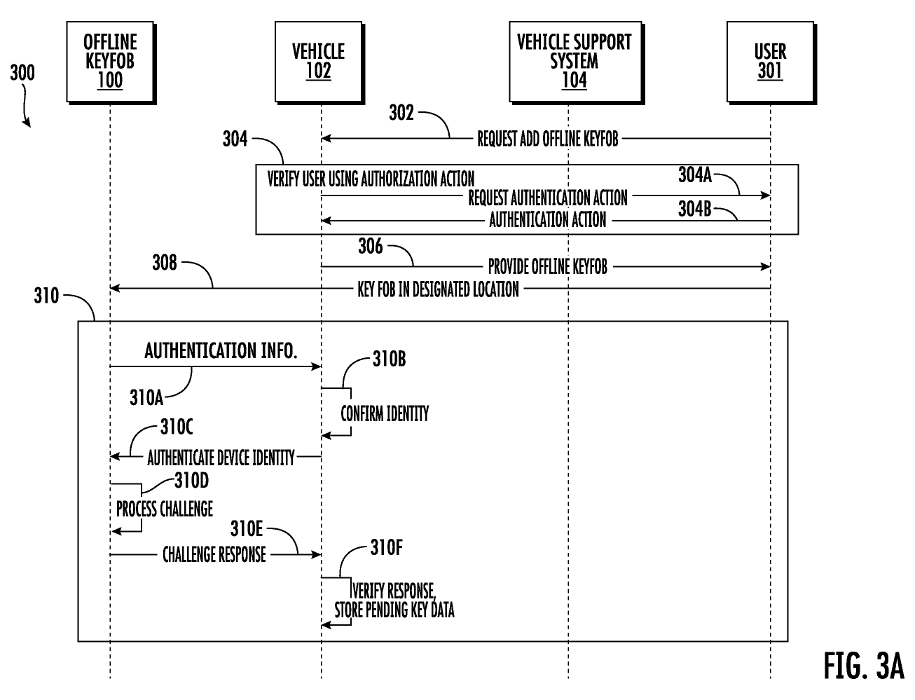

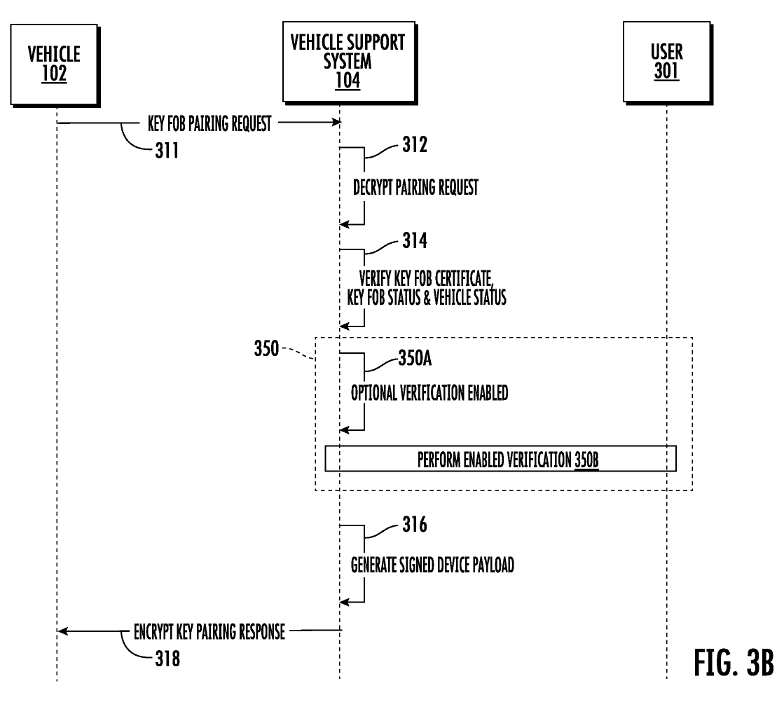

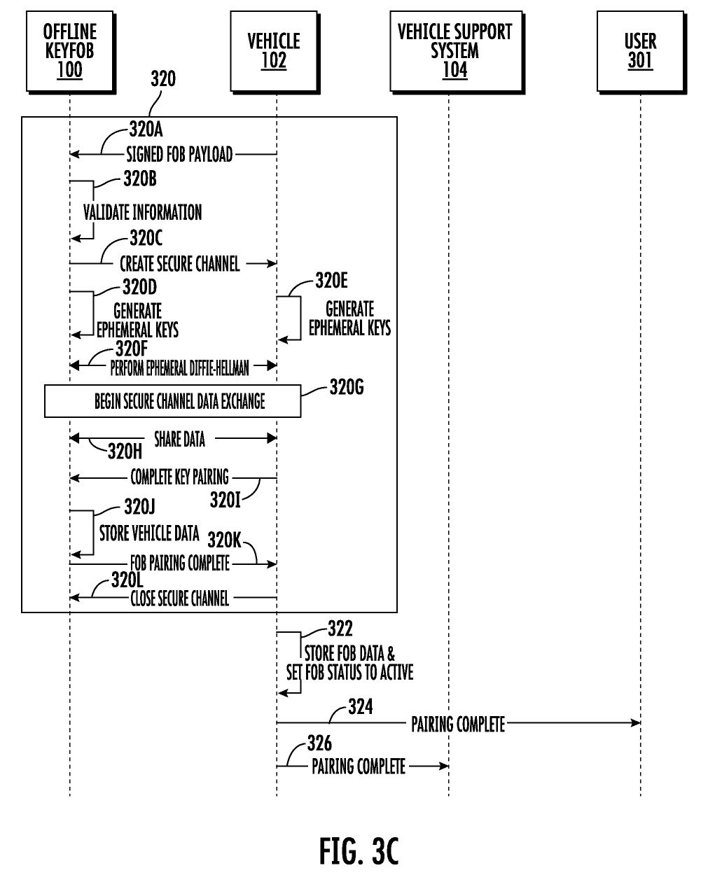

In response to the user being an authorized user, the key fob module 208 is further configured to verify the offline key fob 100 as being authorized to be paired with the vehicle 102 using the authentication information from the offline key fob 100. For instance, the authorized user may be instructed to place the offline key fob 100 at the designated location 132, so that the key fob module 208 may provide the authentication information using the short range communication protocol at the designated location 132. In some aspects, if the authentication information is verified, the key fob module 208 transmits a key fob pairing request to the vehicle support system 104 to obtain a device payload if the vehicle support system 104 is able to authenticate the vehicle and the offline key fob 100. Using the device payload, the key fob module 208 proceeds to pair with the offline key fob 100 to enable the offline key fob 100 to control the vehicle 102. Details regarding offline key fob 100 pairing process as it relates to the offline key fob 100, the vehicle 102, and the vehicle support system 104 is described in association with FIGS. 3A to 3C.

The communication system 203 is configured to communicate with various external devices/systems, such as, but not limited to, the offline key fob 100 and the vehicle support system 104. Accordingly, among other components, the communication system 203 may include a telematics control unit (TCU) that is configured to establish communication under vehicle-to-everything (V2X) protocol, a BLUETOOTH transceiver to communicate with devices using BLUETOOTH protocol, a global navigation satellite system (GNSS) receiver. In some implementations, the communication system 203 includes short-range communication transceivers for communicating with devices like the offline key fob 100 or portable computing at designated locations 132 of the vehicle 102. For example, a designated location 132 is provided in the passenger cabin and is equipped with an NFC transceiver and/or an UWB transceiver to communicate with the device.

The vehicle support system 104 is configured to manage vehicle accounts including storing information related to authorized users of vehicles (e.g., vehicle 102) and authenticating a respective vehicle and a key fob requested to be paired to the vehicle. In some aspects, the vehicle support system 104 includes as a remote server configured to perform the functions described herein and to communicate with external systems or devices including the vehicle 102 using various communication protocols including, but not limited to, cellular communication. In some aspects, the vehicle support system 104 includes a vehicle account module 134 and a key fob authentication module 136.

The vehicle account module 134 is configured to generate, store, and manage vehicle account records that provide information related to the vehicle 102 and one or more authorized users of the vehicle 102. In a non-limiting example, during an on-boarding process, the vehicle account module 134 is configured to associate a user (e.g., vehicle owner) with the vehicle 102 using verification information such as vehicle title or other legal documents. The user is able to perform the on-boarding process using various techniques, such as but not limited to, interfacing with the infotainment system 202 of the vehicle 102; a software application supported by the vehicle support system 104 and executed by a portable computing device (e.g., mobile phone, tablet), or interfacing with a website associated with the vehicle support system 104. Once completed, the vehicle owner is provided as an authorized user of the vehicle 102 and is permitted to manage keys of the vehicle 102. In some aspects, the vehicle owner may identify other users as authorized users for managing keys of the vehicle 102.

The vehicle account module 134 is further configured to store preferences or settings to be associated with the authorized user. For example, the authorized user may select on or more authorization actions and if appropriate, the expected response by the authorized user. In another example, the authorized user may select optional verifications for pairing key fobs (e.g., secondary verification). In a non-limiting example, the optional verifications includes: request explicit approval from the authorized user 301 (e.g., owner, operator, manager, etc.) via a mobile software application or a web portal supported by the vehicle support system 104; delaying approval response message for a selected period of time; cancel pairing attempt; a cooldown period allowing the authorized user 301 to take corrective action before the offline key fob 100 may be activated; freeze feature that prohibits all pairing requests regardless if the vehicle 102 and/or the vehicle support system 104 have authenticated the offline key fob 100, the authorized user 301, or the vehicle 102 causing the key pairing process 300 to end.

The key fob authentication module 136 is configured to perform one or more authentication operations as part of the key fob pairing process of the present disclosure. As detailed herein, the key fob authentication module 136 is configured to validate a pairing request from the vehicle 102 by authenticating the vehicle 102 and the offline key fob 100. Once validated, the key fob authentication module 136 is configured to transmit an encrypted device payload message to the vehicle 102, which is used by the vehicle 102 to initiate the pairing sequence with the offline key fob 100.

Referring to FIGS. 3A, 3B, and 3C, an example key pairing process 300 performed by the offline key fob 100 having pairing module 116, the vehicle 102 having the key fob module 208, and the vehicle support system 104 having the key fob authentication module 136 is provided.

In some implementations, the key pairing process 300 begins at operation 302 when a user 301 initiates pairing request to add the offline key fob 100, which may be requested using the infotainment system 202. In some variations, the key fob module 208 is configured to perform a pre-condition check to verify it is in an appropriate condition to pair the offline key fob 100. For example, the pre-condition check verifies the vehicle 102 is in park and not in motion; the ignition or power state is in an appropriate mode (e.g., ON); the 12v battery is sufficiently charged; modem authorization and vehicle owner onboarding is complete (e.g., check if information related to the vehicle owner is stored by the infotainment system 202); internet connectivity is available; and/or valet or other service modes are not enabled.

At operation 304, the key pairing process 300 is configured to verify the user 301 requesting the pairing as an authorized user. That is, the key fob module 208 requests the user 301 to provide an authentication action via the user interface device(s) 204, at operation 304A, and the user 301 provides the authentication action, at operation 304B.

Once the authentication action is received, the key fob module 208 is configured to verify the user 301 as an authorized user in response the authentication meeting an expected response of the action or stated differently, satisfies the authentication policy. For example, a one-time passcode entered by the user 301 matches that the passcode of the key fob module 208 or third-party entity; a biometric input matches saved biometric measurement; receive a message from a key fob already paired to the vehicle 102; and/or the user 301 acknowledges pop-up message on a portable device associated with the user 301.

In the event the authentication action does not satisfy the associated authentication policy, the key pairing process 300 ends and a message is provided to the user 301 indicating the user 301 is not authorized to add offline key fob 100. In certain service use cases where the user 301 authentication cannot be verified, authorized vehicle diagnostic tools may be used instead to provide the initial authentication for starting the key learning flow.

If the user 301 is verified as the authorized user, the key fob module 208 is to receive a message from the offline key fob 100. For example, the key fob module 208 is configured to request the authorized user to provide offline key fob 100 at the designated location 132 to communicate with the offline key fob 100, at operation 306.

Once received at the designated location 132, at operation 308, the key pairing process 300 performs an offline key fob authentication at operation 310. That is, the offline key fob 100 transmits authentication information to the offline key fob module 208 via the short range communication protocol at the designated location 132, at operation 310A.

With the authentication information, the key fob module 208, at operation 310B, is configured to confirm the identity of the offline key fob 100 and validate the offline key fob 100 as being genuine using the identity certificate and the root certificate. The key fob module 208 is configured to authenticate the offline key fob 100 using a challenge-response handshake during which the offline key fob module transmits a challenge in the form of a random value to the offline key fob 100 (e.g., operation 310C). The offline key fob 100, via the pairing module 116, processes the random value using stored algorithms and the private key or password to generate a challenge response, at operation 310D. The offline key fob 100 then transmits the response challenge to the vehicle 102, at 310E, and the key fob module 208 verifies the challenge response at operation 310F. If the identity and authenticity of the offline key fob 100 is confirmed, the key fob module 208 saves the authentication information and records a status of the offline key fob 100 as pending.

If the offline key fob 100 cannot be identified and/or authenticated, the key fob module 208 ends the key pairing process 300 and informs the user 301 that the offline key fob 100 could not be authenticated.

After being authenticated by the vehicle 102, the offline key fob 100 is further authenticated by the vehicle support system 104. Referring to FIG. 3B, at operation 311, the key fob module 208 transmits a key fob pairing request to the vehicle support system 104 via the communication system 203. In some aspects, the key fob pairing request is an encrypted telematics message requesting approval to pair with the offline key fob 100. The key fob pairing request may include information, such as, but not limited to: the identity certificate of the offline key fob 100; a device type associated with the offline key fob 100 (e.g., device type may include e.g., fob, card, wearable); versions of hardware and software employed by the offline key fob 100; and/or available diagnostic alerts shared by the offline key fob 100 and the vehicle 102 during pairing. The key fob pairing request may also contain details of the vehicle 102, such as, but not limited to: an identity certificate or other unique identifier of the vehicle 102; hardware and software versions of the vehicle 102; and/or any diagnostic alerts or vehicle status values.

In implementations in which the key fob pairing request is encrypted, the key fob authentication module 136 of the vehicle support system 104 is configured to have the appropriate keys to decrypt the telematics message and access the information, at operation 312.

Using the information of the key fob pairing request, the key fob authentication module 136 is configured to perform a validation process of the offline key fob 100 and the vehicle 102, at operation 314. In a non-limiting example, the validation process for the offline key fob 100 includes: validating the identity certificate of the offline key fob 100 as being genuine using the root certificate; confirming the identity certificate of the offline key fob 100 has been not revoked or otherwise invalidated using, for example, information from a manufacture of the offline key fob 100; and/or verifying the offline key fob 100 has not been marked as lost or stolen in a database supported by a third party (e.g., the third party may be key fob manufacturer and/or dealership).

The key fob authentication module 136 may perform similar checks on the vehicle 102, at operation 314. For example, the key fob authentication module 136 validates the identity certificate and revocation status of the vehicle 102; confirms if the vehicle 102 has completed owner onboarding using, for example, information from the vehicle account module 134; and verifies the vehicle 102 has not been marked stolen in a database.

If any of the validations associated with the offline key fob 100 and/or the vehicle 102 is not verified, the key fob authentication module 136 transmits a denial response as a telematics message to the vehicle 102 to inform the user 301 that the pairing process cannot be completed (not shown in FIG. 3B). In some implementations, any pending data saved by the vehicle 102 is also deleted.

If the verifications are successful, the key fob authentication module 136 generates a signed device payload, at operation 316. The device payload may include information used to authenticate the vehicle 102 and establish a secure channel. The information in the device payload may include the identity certificate of the vehicle 102; a public key or credentials for password-authenticated key exchange (PAKE) protocols; a counter or server approval timestamp to determine payload freshness; restrictions on which interfaces the offline key fob 100 may communicate with the vehicle 102; radio technologies and versions supported by the vehicle 102; and/or a list of mutually supported protocol versions.

At operation 318, the key fob authentication module 136 encrypts and transmits the signed device payload to vehicle 102 an encrypted pairing response (e.g., an encrypted signed payload message). The encrypted pairing response may also include information indicating that the pairing request is approved.

In some aspects, it may be necessary to wait for vehicle 102 to be started, which may prompt for the pending key to be placed back on vehicle’s interior NFC reader.

In some aspects, since the offline key fob 100 does not have connectivity (e.g., internet connectivity) to the vehicle support system 104, the offline key fob 100 may not receive timely software updates including updates to public keys to verify payload signatures when the vehicle support system 104 may replace signing keys associated with the vehicle support system 104. To have the vehicle support system 104 freely generate new signing keys, the device payloads include a certificate for the current signing key used by the vehicle support system 104. In a non-limiting example, the certificate may be provided with the payload alongside the signature using cryptographic message syntax (CMS) defined in Request for Comment (RFC) 5652.

The offline key fob 100 may later be able to use the root certificates already provisioned to it to validate the authenticity of any new signing key certificates. Additionally, the offline key fob 100 may track the latest received validity start time within the signing key certificates to “revoke” all prior signing key certificates containing older timestamps (e.g., NotBefore timestamps) without using large revocation lists, a constantly running real-time clock that consumes battery power, and/or an active connection to certificate management systems supported by the vehicle support system 104.

In some aspects, there may be an indefinite delay between the vehicle 102 providing the key fob pairing request to the vehicle 102 receiving the pairing approval response from the vehicle support system 104, such that the vehicle 102 is turned off and/or the offline key fob 100 is removed from the designated location 132. In such case, the vehicle 102 waits until the next time the vehicle 102 is started to pair with the offline key fob 100. If the offline key fob 100 is not already at the designated location 132 and ready to complete pairing, the infotainment system 202 may prompt via the user interface devices 204 that pairing approval has been received and provide instructions to place the offline key fob 100 at the designated location 132.

With the device payload, the vehicle 102 and the offline key fob 100 perform a pairing process 320. In some aspects, the key fob module 208 of the vehicle 102 is configured to decrypt the message having the device payload using associated keys, and provides the device payload having the vehicle certificate to the offline key fob 100, at operation 320A. The pairing module 116 of the offline key fob 100 is configured to performs a series of validations, at 320B. In a non-limiting example, the offline key fob 100 is configured to validate a signing certificate, a root certificate of the vehicle support system 104 which is already provisioned to the offline key fob 100, validate the payload signature, and/or obtain a vehicle pairing data associated with the vehicle (e.g., certificates, public keys, PAKE credentials, etc.).

In some aspects, the offline key fob 100 may reject the device payload in response to one or more validations not being satisfied or if the freshness value (e.g., counter or date/time) indicate an old or replayed message for a different vehicle that is no longer authorized to pair with the offline key fob 100. With no validation, the offline key fob 100 transmits a message indicating pairing not validated and end pairing process (not shown in FIG. 3C).

If all validations pass, then the offline key fob 100 informs the vehicle 102 to proceed with a handshake for secure channel establishment, at operation 320C. Various techniques and protocols may be used to create the secure channel in a way that provides mutual authentication, forward secrecy, and replay protection, such as the C(2e, 2s, Elliptic Curve Cryptography (ECC) Computational Diffie-Hellman (CDH)) technique from SP800-56A and the SPAKE2 protocol drafted as RFC 9382. For example, at operations 320D and 320E, the pairing module 116 of the offline key fob 100 and the key fob module 208 of the vehicle 102 generate ephemeral keys (e.g., cryptographic keys), respectively, at operation 320F perform ephemeral Diffie-Hellman to establish the secure channel.

Following the handshake of operations 320D and 320E, the secure channel is established (operation 320G) and the secure channel itself may borrow from existing protocols to encrypt and authenticate all exchanged session data, such as transport layer security (TLS) or GlobalPlatform’s SCP03.

Through this secure channel, the vehicle 102 and the offline key fob 100 may share any data used to successfully complete pairing, at operation 320H. The shared data may include, but is not limited to: hardware and software information, supported wireless radio capabilities, selected protocol versions, keys and initial rolling code values for remote commands, keys and data for performing out of band Bluetooth-type pairing, and data required to setup additional radio interfaces. The vehicle 102 and the offline key fob 100 may also provide confirmation values and attestations may also be sent through the secure channel to verify successful delivery, derivation, and storage of the exchanged data.

Once pairing data is successively exchanged, the key fob module 208 notifies the pairing module 116 that pairing is complete at 320I. The pairing module 116 stores data related to the vehicle 102, at operation 320J and transmits a pairing completion message to the vehicle 102, at operation 320K. The vehicle 102 closes the secure channel by discarding all ephemeral keys, at operation 320L.

At operation 322, the key fob module 208 stores data associated with the offline key fob 100 and sets the status of the offline key fob 100 to active. In some implementations, the key fob module 208 notifies the authorized user by using one or more user interface devices 204 and providing a message indicating that pairing is complete and the offline key fob 100 is activated, at operation 324. The key fob module 208 may also transmit a telematics message indicating the successful pairing to the vehicle support system 104, at operation 326.

In some variations, the key pairing process 300 may include the vehicle support system 104 checking and performing one or more optional verifications enabled by the authorized user, as described above. For example, referring to FIG. 3B, at operation 350, the key fob authentication module 136 performs an optional verification process (e.g., a secondary verification). At operation 350A, the key fob authentication module 136 determines if additional verifications are to be performed based on the information provided in the vehicle account associated with the vehicle. At operation 350B, the key fob authentication module 136 performs the enabled optional verifications.

In addition to the authorized user 301 or in lieu of the authorized user 301, the optional verifications may be automatically enabled by the vehicle original equipment manufacturer based on, for example factors indicating unauthorized vehicle key management. In a non-limiting example, the optional verification may be enabled based on: a make and/or model of the vehicle 102, a current geolocation of the vehicle 102, the date and/or time of the pairing request was generated, a region where the vehicle 102 was sold, applicable cybersecurity regulations, analytics of recent vehicle thefts, and/or other factors indicating unauthorized vehicle key management.

The key pairing process 300 of FIGS. 3A, 3B, and 3C provides a secure process for an authorized user to manage and pair the offline key fob 100 to the vehicle 102. In some implementations, the offline key fob 100 pairing can take place when the vehicle 102 is in a vehicle assembly facility. At times, the key pairing process 300 may not be used since the authorized user 301 (e.g., owner of the vehicle) may not be assigned and an onboarding process is not complete. The key pairing process 300 may also not be suitable if there are no existing vehicle keys for the vehicle 102.

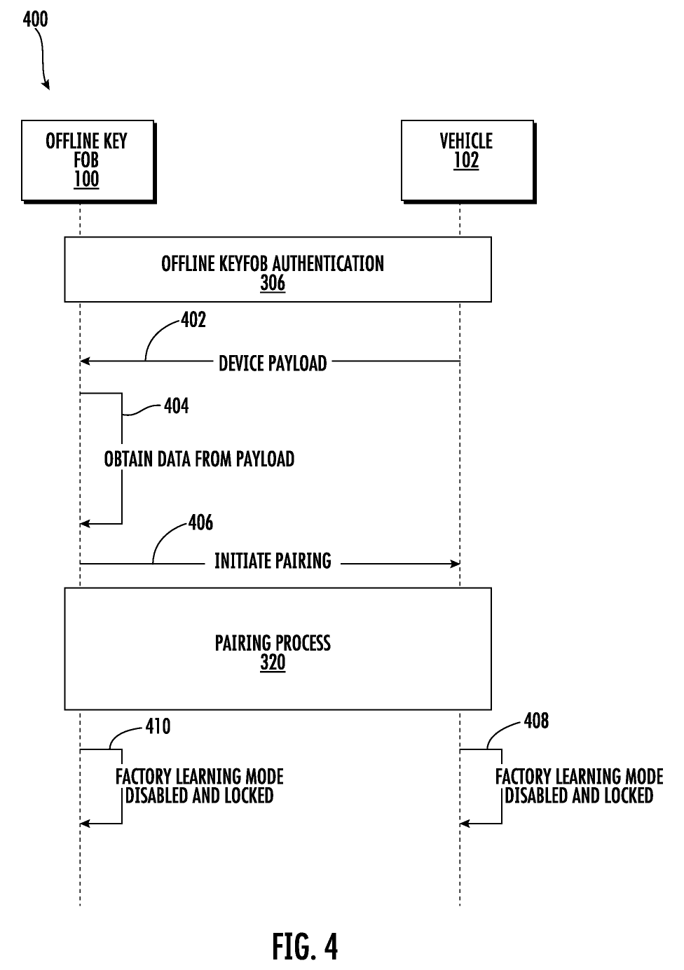

In one form, referring to FIG. 4, the offline key fob 100 may be paired to the vehicle 102 using an key pairing process 400, which varies from the key pairing process 300. For instance, with the vehicle 102 and the offline key fob 100 in a factory learning mode, the authorized user verification and other checks performed by the key fob pairing process may be skipped. In addition, the vehicle 102 is not in communication with the vehicle support system 104, and a user is a technician at the manufacturing facility.

With the offline key fob 100 at the designated location 132, the key pairing process 400 may begin with the offline key fob authentication of operation 306 of FIG. 3A. That is, the key fob module 208 is configured to receive authentication information of the offline key fob 100. Even in the factory learning mode, the vehicle 102 may reject pairing with an offline key fob 100 that does not provide a valid identity certificate.

After the offline key fob authentication operation 306, the key fob module 208 generates and transmits an unsigned device payload for the offline key fob 100, at operation 402. The offline key fob 100 obtains certificates and data of the vehicle provided in the unsigned device payload, at operation 404. Since the offline key fob 100 is in the factory learning mode, has not yet paired with other vehicles, and has not been given to customers, there is no concern that a driver can become stranded from an unauthorized pairing that overwrites current vehicle data. Accordingly, the offline key fob 100 verifies the payload and is ready for pairing. Accordingly, the pairing module 116 notifies the vehicle 102 to initiate pairing, at operation 406.

The key pairing process 400 the proceeds to perform the pairing process of operation 320 FIG. 3C. Once the pairing process 320 is complete, the vehicle 102 and the offline key fob 100 are taken out of factory learning mode and locked, at operation 408 and 410, respectively. The offline key fob 100 is now active and ready for use. In some implementations, the key fob module 208 may notify the technician that pairing is complete and the offline key fob 100 is active.

Once the vehicle 102 is assembled and is in communication with the vehicle support system 104, the vehicle 102 may transmit a telematic message indicative of the pairing status to the vehicle support system 104.

In some variations, when the offline key fob 100 and the vehicle have both successfully exchanged and stored pairing data, a final pairing step may include to complete setup for any additional radios, such as Bluetooth pairing, which may happen automatically or upon additional user input (e.g., press and hold a button 114 on the key fob).

The offline key fob pairing process of the present disclosure (e.g., processes 300 and 400) enforce mutual authentication, use strong encryption for data exchange, and integrates with the vehicle support system 104 to centrally manage when the offline key fob 100 can be paired to the Vehicle 102. The offline key fob pairing process may also provide increased compatibility with a variant offline pairing process to be used in vehicle assembly plants.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, components (e.g., the communication module 110 having the pairing module 116, the control module 112, the user profile module 206, the key fob module 208, the vehicle account module 134, and the key fob authentication module 136), may be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory device is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a universal serial bus (USB) drive, a compact disc (CD), a digital versatile disk (DVD), or a Blu-ray Disc).

The apparatuses and methods described in this application (e.g., processes 300 and 400, the communication module 110 having the pairing module 116, the control module 112, the user profile module 206, the key fob module 208, the vehicle account module 134, and the key fob authentication module 136) may be partially or fully implemented by a special purpose computer created by configuring a general-purpose computer (e.g., computing device) to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system comprising:
a vehicle system including one or more computing devices configured to:
identify a user as an authorized user of a vehicle using an authorization action associated with the user in response to receiving a key pairing request to pair an offline key fob to the vehicle;
verify the offline key fob as being authorized to be paired with the vehicle using an authentication information provided by the offline key fob using a short range communication protocol in response to the user being the authorized user;
transmit a device payload to the offline key fob using the short range communication protocol; and
pair to the offline key fob using the device payload to enable the offline key fob to control the vehicle.

2. The system of claim 1, wherein the one or more computing devices of the vehicle system is configured to:
transmit, to a remote server, a key fob pairing request to obtain approval to pair with the offline key fob; and
decrypt a signed payload message to obtain the device payload from the remote server in response to the remote server approving pairing.

3. The system of claim 1, wherein the short range communication protocol includes at least one of a near field communication protocol or ultra-wideband protocol.

4. The system of claim 1, wherein the authorization action includes at least one of: a message from one or more key fobs already paired to the vehicle; obtain and verify login credentials associated with the authorized user; confirmation of a one-time password entered by the user; or a biometric authentication.

5. The system of claim 1, wherein the authentication information includes at least one of an identity certificate, a root certificate, or a private key.

6. The system of claim 1, wherein to verify the offline key fob, the one or more computing devices of the vehicle system is configured to execute a challenge-response handshake with the offline key fob, and determine the offline key fob is authorized to be paired with the vehicle in response to a challenge response from the offline key fob being verified with expected response.

7. The system of claim 1, further comprising:
a remote server configured to:
decrypt the key pairing request from the vehicle system to obtain information associated with the vehicle and the offline key fob,
verify a certificate of the offline key fob, status of the offline key fob, and status of the vehicle; and
transmit an encrypted signed payload message to authorize pairing of the offline key fob to the vehicle in response to the certificate of the offline key fob, the status of the offline key fob, and the status of the vehicle being verified, wherein
the one or more computing devices of the vehicle system is configured to decrypt the encrypted signed payload message to obtain the device payload.

8. The system of claim 7, wherein the remote server is configured to transmit the encrypted signed payload message in response to a secondary verification unrelated to an authentication of the offline key fob.

9. The system of claim 8, wherein the secondary verification is enabled by the user and includes at least one of: obtaining explicit approval from the authorized user, delaying approval response message for a selected period of time, cancelling pairing attempt, providing a cooldown period allowing the authorized user to take corrective action before the offline key fob may be activated; and determining whether the authorized user enabled prohibition of all pairing requests.

10. The system of claim 1, wherein the one or more computing devices of the vehicle system is configured to:
identify the user as the authorized user of the vehicle in response to the offline key fob and the vehicle not being in a factory learning mode; and
bypasses identification of the user as the authorized user of the vehicle using the authorization action associated with the user in response to receiving the key pairing request to pair the offline key fob to the vehicle and in response to the offline key fob and the vehicle being in the factory learning mode.

11. A non-transitory computer-readable medium comprising instructions for pairing an offline key fob to a vehicle that, when executed by one or more processors perform operations including to:
identify a user as an authorized user of the vehicle using an authorization action associated with the user in response to receiving a key pairing request to pair the offline key fob to the vehicle;
verify the offline key fob as being authorized to be paired with the vehicle using authentication information provided by the offline key fob using a short range communication protocol in response to the user being the authorized user;
transmit a device payload to the offline key fob using the short range communication protocol;
establish a secure channel with the offline key fob using cryptographic keys in response to the offline key fob validating the device payload; and
pair to the offline key fob using the secure channel and the device payload to enable the offline key fob to control the vehicle.

12. The non-transitory computer-readable medium of claim 11, further comprising instructions that, when executed by the one or more processors, perform operations including:
transmit, to a remote server, a key fob pairing request to obtain approval to pair with the offline key fob; and
decrypt a signed payload message to obtain the device payload from the remote server in response to the remote server approving pairing.

13. The non-transitory computer-readable medium of claim 11, wherein the short range communication protocol includes at least one of a near field communication protocol or ultra-wideband protocol.

14. The non-transitory computer-readable medium of claim 11, wherein the authorization action includes at least one of: a message from one or more key fobs already paired to the vehicle; obtain and verify login credentials associated with the authorized user; confirmation of a one-time password entered by the user; or a biometric authentication.

15. The non-transitory computer-readable medium of claim 11, wherein the authentication information includes at least one of an identity certificate, a root certificate, or a private key.

16. The non-transitory computer-readable medium of claim 11, further comprising instructions that, when executed by the one or more processors, perform operations including, execute a challenge-response handshake with the offline key fob, and determine the offline key fob is authorized to be paired with the vehicle in response to a challenge response from the offline key fob being verified with an expected response.

17. The non-transitory computer-readable medium of claim 11, further comprising instructions that, when executed by the one or more processors, perform operations including:
decrypt the key pairing request to obtain information associated with the vehicle and the offline key fob,
verify a certificate of the offline key fob, status of the offline key fob, and status of the vehicle; and
transmit an encrypted signed payload message to authorize pairing of the offline key fob to the vehicle in response to the certificate of the offline key fob, the status of the offline key fob, and the status of the vehicle being verified, wherein the encrypted signed payload message is decrypted to obtain the device payload.

18. The non-transitory computer-readable medium of claim 17, further comprising instructions that, when executed by the one or more processors, perform operations including: executing a secondary verification unrelated to an authentication of the offline key fob, wherein the encrypted signed payload message is transmitted in response to the secondary verification being met.

19. The non-transitory computer-readable medium of claim 18, wherein the secondary verification is enabled by a user and includes at least one of: obtaining explicit approval from the authorized user, delaying approval response message for a selected period of time, cancelling pairing attempt, providing a cooldown period allowing the authorized user to take corrective action before the offline key fob may be activated; determining whether the authorized user enabled prohibition of all pairing requests.

20. A method of pairing an offline key fob to a vehicle, comprising:
identifying, by a vehicle system, a user as an authorized user of the vehicle using an authorization action associated with the user in response to receiving a key pairing request to pair an offline key fob to the vehicle;
verifying, by the vehicle system, the offline key fob as being authorized to be paired with the vehicle using an authentication information provided by the offline key fob using a short range communication protocol in response to the user being the authorized user, wherein the authentication information includes at least one of an identity certificate, a root certificate, or a private key;
transmitting, by the vehicle system to a remote server, a key fob pairing request to obtain approval to pair with the offline key fob;
decrypting, by the vehicle system, a signed payload message to obtain a device payload from the remote server in response to the remote server approving pairing;
transmitting, by the vehicle system, the device payload to the offline key fob using the short range communication protocol;
establishing, by the vehicle system, a secure channel with the offline key fob using cryptographic keys in response to the offline key fob validating the device payload; and
pairing, by the vehicle system, the vehicle to the offline key fob using the secure channel, one or more shared data, and the device payload to enable the offline key fob to control the vehicle.
